(19) United States
(12) Patent Application Publication
(10) Pub. No.: US 2007/0296937 A1
(43) Pub. Date: Dec. 27, 2007

(54) ILLUMINATION LIGHT IN IMMERSION LITHOGRAPHY STEPPER FOR PARTICLE OR BUBBLE DETECTION

(75) Inventors: Toshiharu Furukawa, Essex Junction, VT (US); Mark C. Hakey, Fairfax, VT (US); Steven J. Holmes, Guilderland, NY (US); David V. Horak, Essex Junction, VT (US); Charles W. Koburger, Delmar, NY (US); Peter H. Mitchell, Jericho, VT (US)

Correspondence Address: FREDERICK W. GIBB, III;Gibb & Rahman, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 11/426,458

(22) Filed: Jun. 26, 2006

(51) Int. Cl. G03B 27/42

(52) U.S. Cl. 355/53; 355/30

(57) ABSTRACT

Embodiments of the invention present a system, method, etc. for illumination light in an immersion lithography stepper for particle or bubble detection. More specifically, embodiments herein provide an immersion lithography expose system comprising a wafer holder for holding a wafer, an immersion liquid for covering the wafer, an immersion head to dispense and contain said immersion liquid, and a light source adapted to lithographically expose a resist on the wafer. The system also comprises a light detector at a first location of the immersion head and a laser source at a second location within said immersion head.

### BACKGROUND OF THE INVENTION

1. Field of the Invention

Embodiments of the invention present a system, method, etc. for illumination light in an immersion lithography stepper for particle or bubble detection.

2. Description of the Related Art

Lithography, in the context of building integrated circuits (ICs) such as microprocessors and memory chips, is a highly specialized printing process used to put detailed patterns onto silicon wafers. An image containing the desired pattern is projected onto the wafer through a mask defining the pattern. Prior to light projection through the mask, the wafer is coated with a thin layer of photosensitive material called “resist.” The bright parts of the image pattern cause chemical reactions which cause the resist material to become more soluble, and thus dissolve away in a developer liquid; the dark portions of the image remaining insoluble. After development, the resist forms a stenciled pattern across the wafer surface which accurately matches the desired mask pattern. Finally, the pattern is permanently transferred onto the wafer surface in an etching process wherein, for example, a chemical etchant is used to etch the portions of the wafer surface not protected by resist. Many of the conventional processes mentioned herein are described in previous patents and publications, such as U.S. Patent Application Publication No. 2005/0213061 A1, which is incorporated herein by reference.

With the image resolution of lithography as the limiting factor in the scaling of the IC devices, improvements in lithographic components and techniques are critical to the continued development of more advanced and compact ICs. Immersion lithography is becoming a major technique for extending lithography to smaller dimensions. A number of practical issues to implementing immersion lithography remain, however, including maintaining a pure, non-obstructing transmission medium and compatibility of the tools and wafer with the immersion liquid medium. Purified and degassed water, having a light absorption of 5% at working distances up to 6 mm and an index of refraction n=1.47, may be a suitable medium for immersion lithography. However, particles, debris, and other foreign matter may be inadvertently introduced into the transmission medium, thereby adversely affecting the image resolution. Further, problems remain relating to the tendency to form bubbles during the scanning processing. The stage on a lithography exposure tool steps from location to location across a wafer, scanning the reticle image for each field. To achieve high throughput, the stage must accelerate rapidly, move accurately to the next field location, settle, scan the image and then step to the next location all in a short period of time. A water medium is susceptible to forming micro-bubbles and nano-bubbles in the cavitation-prone water layer near the moving surfaces.

### SUMMARY OF THE INVENTION

Embodiments of the invention present a system, method, etc. for illumination light in an immersion lithography stepper for particle or bubble detection. More specifically, embodiments herein provide an immersion lithography expose system comprising a wafer holder for holding a wafer, an immersion liquid for covering the wafer, an exposure head to contain the immersion liquid, and a light (exposure) source adapted to lithographically expose a resist on the wafer. The system also comprises at least one light detector at a first end of the immersion head and can comprise a laser source at a second end of the immersion head. The light detector can also be proximate the second end, a third end, and/or a fourth end of the immersion head.

Both the exposure source and the laser source illuminate the immersion liquid. Foreign matter within the immersion liquid scatters this light. The scattered light is collected by the light detector, thereby identifying the foreign matter within the immersion liquid. The system further comprises at least one lens, wherein the lens is adapted to focus the scattered light onto the light detector. The lens is proximate the first end, the second end, the third end, and/or the fourth end of the immersion head. The light source is positioned outside of the immersion head.

Embodiments herein further comprise a method for detecting foreign matter in an immersion lithography expose system, wherein the method begins by lithographically exposing a wafer with light from a light source. Next, the light is transmitted through immersion liquid covering the wafer (or a portion of the wafer), wherein light is scattered by the foreign matter within the immersion liquid. Subsequently, the scattered light is focused onto at least one light detector via lens(es), wherein the light detector detects the scattered light.

In addition, the method could comprise transmitting a laser beam through the immersion liquid, comprising orienting the laser beam parallel to the wafer surface, wherein the laser beam is scattered by the foreign matter within the immersion liquid to produce a scattered laser beam. Following this, the scattered laser beam is focused onto the light detector via lens(es), wherein the light detector detects the scattered laser beam.

Accordingly, embodiments of the invention provide a method for detecting defects and bubbles in the immersion fluid through monitoring of scattered exposure radiation. By using the light source that is already there, the amount of hardware changes needed is significantly reduced. In addition, the wavelength of the illumination light is very short which yields higher sensitivity to small defects. Embodiments herein further provide a similar light collection mechanism built into the immersion head, with the addition of an independent light source.

These, and other, aspects and objects of the present invention will be better appreciated and understood when considered in conjunction with the following description and the accompanying drawings. It should be understood, however, that the following description, while indicating embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a cross sectional view of an immersion lithography expose system;

FIG. 2 is a cross sectional view of an immersion lithography expose system showing light scattering;

FIG. 3 is a top view of an immersion lithography expose system;

FIG. 4 is a schematic of a signal to noise scattering model;

FIG. 5 is a graph illustrating signal ratio versus window height;

FIG. 6 is a perspective view of an immersion lithography expose system showing a laser source;

FIG. 7 is a top view of an immersion lithography expose system showing a laser source; and

FIG. 8 is a flow diagram illustrating a method for detecting foreign matter in an immersion lithography expose system.

### DETAILED DESCRIPTION OF PREFERRED EMBODIMENTS OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

Embodiments of the invention provide a method for detecting defects and bubbles in the immersion fluid through monitoring of scattered exposure radiation. By using exposure radiation that is already there, the amount of hardware changes needed is significantly reduced. In addition, the wavelength of the exposure radiation is very short (such as 193 nm) which yields higher sensitivity to small defects. Embodiments herein further provide a similar light collection mechanism built into the immersion head, with the addition of an independent light source.

More specifically, embodiments of the invention comprise use of lenses which make up part of the inside of the immersion head of an optical stepper. Lenses with a larger diameter (higher numerical aperture) provide higher resolution, and are more desirable for this application. The larger the area of the lens(es), the higher the resolution. The collection lenses are placed away from the area of the (pattern) illumination, so underlying topography or particles in the resist or ARC (anti-reflective coating) on the wafers are not counted. The majority of the light scattered from the on-wafer topography (having a trajectory by which it could enter the collection optics) will have to travel a relatively long distance through the ARC/resist material and would be absorbed thereby. Resist top-surface defects will still be detected. In addition, in an alternative embodiment, a similar lens as used for collecting the scattered light can be used to focus a light beam, such as from a laser source, to create a second embodiment for particle/bubble detection. The Lens or Optical Element is designed to allow the laser light to travel parallel and as close to the wafer surface as possible. This second embodiment enables detection of fluid defects outside of the critical printing volume (and would necessitate having a laser which will not expose the resist).

Some embodiments of the invention use the exposure illumination laser to provide the light source for particle/bubble detection. First, embodiments herein are relatively easy and inexpensive to implement because the illumination system does not need to be integrated into the immersion head (it is already an integral part of the lithography system). Second, embodiments herein use the optimum wavelength (λ) of light, which is the exposure wavelength, such as a wavelength of 193 nm. Shorter wavelengths would be preferred since the shorter the wavelength the more efficient the scattering; scattering is proportional to 1/(λ⁴) so that even a small wavelength decrease yields a large increase in scattering efficiency. Wavelengths much shorter than the exposure wavelength, however, are absorbed by the immersion fluid, and would expose the patterning resist with unwanted images. Thus, in a second type of embodiment, wherein illumination employing stand-alone lasers is employed, wavelengths longer than the exposure wavelength must be used, thus degrading sensitivity.

Third, when employing the exposure illumination for particle detection, signal from scattering particles/bubbles in the liquid is detected only from the area of interest, i.e. the part of the immersion fluid being irradiated by the exposure light during exposure. Defects which remain confined to the periphery of the immersion head, outside of the normal exposure region, will not contribute to defect measurement “noise”. In addition, because the scattered light is generated during the scan of the exposure field, correlation with wafer-level defects can lead to easier debugging of defect generation.

Fourth, embodiments herein are insensitive to scattering of reflected light from the various surfaces (walls) of the immersion head (since the walls of the immersion head will not be illuminated during usual processes).

As the illumination/detection beam hits the wafer surface, light scattered from surface topography can confuse the detection system. For illumination at the exposure wavelength, however, resist is absorbing and the ARC very absorbing. This absorption, combined with a very shallow angle of collection, will make the relative intensity of light scattered from the wafer pattern or from particles on the wafer covered by ARC and resist very low, as opposed to intensity of light scattered from particles within the immersion fluid.

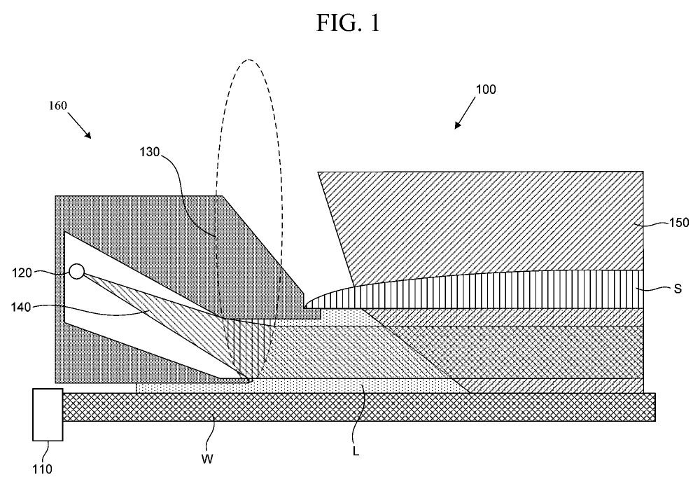

A cross section of an immersion lithography expose system 100 is illustrated in FIG. 1.

Specifically, the system 100 comprises a wafer holder 110 for holding a wafer W, wherein an immersion liquid L (also referred to herein as “immersion fluid”) is disposed over the wafer W. The wafer holder 110 could comprise commonly known fasteners for removably securing an object into place, such as, for exemplary purposes only, clamps, pins, grooves, vacuum and the like. A light detector 120 is provided integrated into the immersion head 160; and a collection lens 130 is provided between the light detector 120 and the immersion liquid L. A portion of the collection lens 130 is illustrated herein using dotted lines. An exposure light 150 is directed through a last stepper lens S and into the immersion liquid L. Scattered portions of the exposure light 150 can be directed through a portion of the collection lens 130, through a collection cone 140, and into the light detector 120. Specifically, portions of the exposure light 150 can be scattered when they come into contact with foreign matter within the immersion liquid L, such as bubbles, particles, debris, and the like.

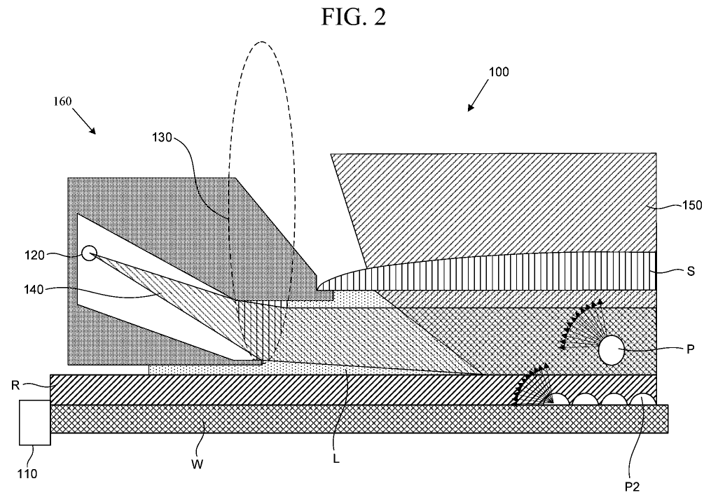

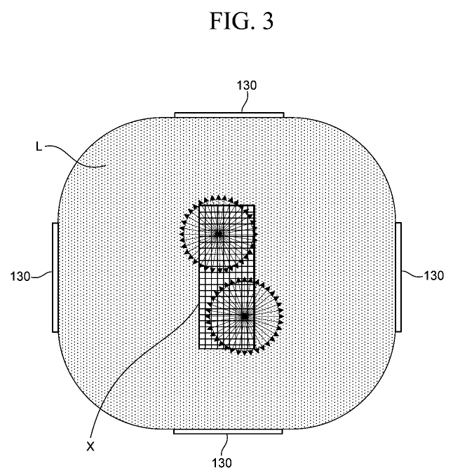

For example, FIG. 2 illustrates light scattered from a particle P in the immersion liquid L and a particle (or pattern) P2 on the wafer W. An ARC and resist R will absorb some of the exposure light 150. However, because the light detector 120 is a long distance away from the illumination scatter site (relative to lens 130), the scattered light from the sites on the wafer W will have to travel a very long distance through the ARC and resist R, where a majority of it will be absorbed. FIG. 3 is a top view of the immersion lithography expose system 100, wherein X denotes the exposure area.

Signal to noise modeling can calculate the ratio of scattered light signal from a particle of interest in the immersion fluid versus the light scattered from a particle on the wafer's surface. This modeling estimates signal degradation caused by structures and FM (foreign matter) on the wafer or surface FM.

In one example, the modeling can comprise many assumptions. First, both particles are the same size and scatter the light to the detector with the same yield. Second, the scattered light from the wafer surface has to pass through the resist & ARC on the way to the detector. It is also assumed that the particle does not significantly alter the ARC or Resist thickness. Normally the spun on material will come up on the particle, but the scattering part may not be as well covered as in this model. Third, an estimated absorption of 20% in the resist and 80% in the ARC as light is reflected from particles or topography orthogonally to the wafer surface. This is the single, shortest path for the scattered light. Longer light paths will result in more absorption by the resist and ARC so. Both of these absorption values are quite conservative.

In one example, the bottom of the collection optics (130) is 60 μm from the wafer surface and the top is assumed to be 1-6 cm above the wafer surface (referred to below as “window height”). Furthermore, the illumination light angle to the wafer varies and can get very high as numerical aperture (NA) increases. This illumination angle does not have to be considered because the scattering off the particles will behave the same. In this example, collection optics are 40 mm away from the scattering particle.

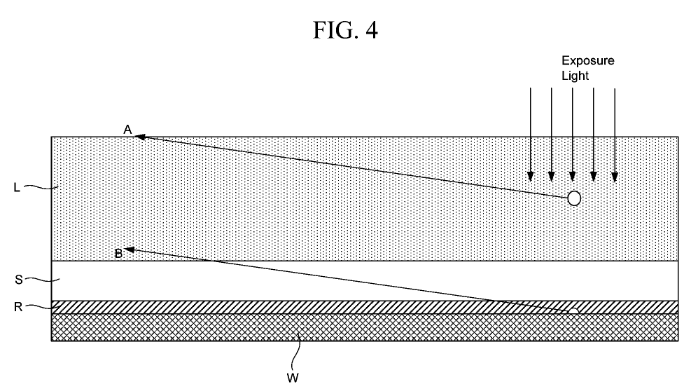

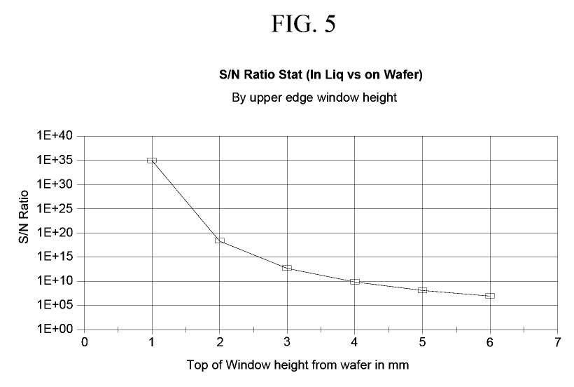

A schematic of the model is illustrated in FIG. 4. The plot of the ratio of signal from a particle in the liquid (light ray A) divided by the signal from a particle on the surface below the resist/ARC (light ray B) as a function of top window height above the wafer is illustrated in FIG. 5. The height of the collection optics has a large impact of the signal to “noise” of the measurement. The variation in the ratio is large enough (up to 1E+35) that the window height can be chosen to balance the scattered light signal gathering power versus the S/N from the wafer surface.

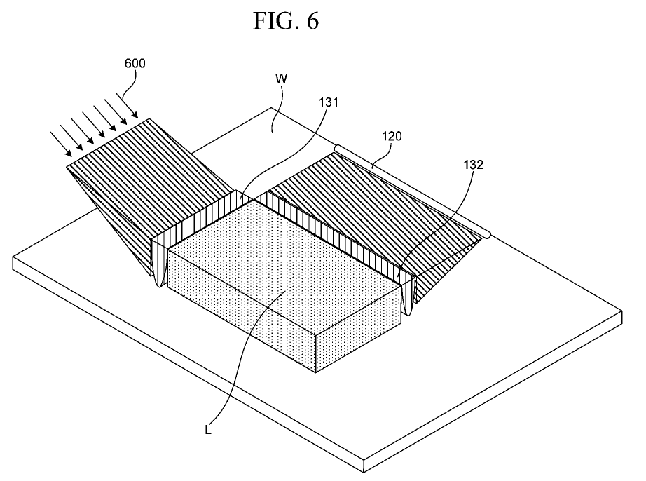

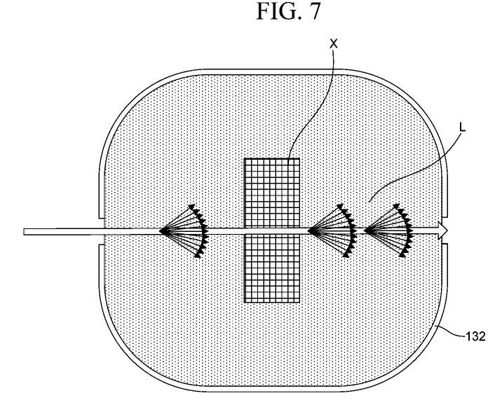

As illustrated in FIGS. 6 and 7, the system could further comprise a laser source 600 proximate the wafer W, wherein the laser source 600 is positioned at one location along the periphery of the immersion head, and the light detector 120 at a different location (not immediately opposite the location of source 600). The laser source produces a laser beam that is directed through a first lens 131 and into the immersion liquid L. Scattered portions of the laser beam can be directed through a second lens 132 and into the light detector 120. As illustrated in FIG. 7, portions of the laser beam can be scattered when they come into contact with foreign matter within the immersion liquid L, such as bubbles, particles, debris, and the like. It is further contemplated, in another embodiment, that the light detector 120 and the lens 130 could also be positioned proximate second, third, and/or fourth positions of the immersion head.

Accordingly, embodiments of the invention present a system, method, etc. for the use of illumination light in an immersion lithography stepper for particle or bubble detection. More specifically, embodiments herein provide an immersion lithography expose system 100 comprising a wafer holder 110 for holding a wafer W, an immersion head 160 containing an immersion liquid L for covering the wafer W, and a light source (i.e., exposure light 150) adapted to lithographically expose a resist on the wafer W. As discussed above, embodiments herein are relatively easy and inexpensive to implement because the light source 150 does not have to be integrated into the immersion lithography head (it is already an integral part of the lithography system).

The system 100 also comprises at least one light detector 120 at a first peripheral location on the immersion head 160 and could comprise a laser source 600 at an additional peripheral location of the immersion head 160. The light detector 120 can also be proximate the second peripheral location, a third peripheral location, and/or a fourth peripheral location of the immersion head 160. The direct laser light however does not enter any of the detectors. Both the light source 150 and the laser source 600 are adapted to transmit light through the immersion liquid L to scatter off of particles within the immersion liquid L and thence to the light detector 120, to identify foreign matter within the immersion liquid L. As discussed above, the light source 150 and the laser source 600 can employ detection light whose wavelength is, for example, at 193 nm. It is contemplated that a detection light having another wavelength could be utilized, such as, for example, a wavelength between 157 nm and 450 nm. Short wavelengths are preferred since the shorter the wavelength the more efficient the scattering. Scattering is proportional to 1/(λ⁴) so that even a small wavelength decrease yields a large increase in scattering efficiency.

The system 100 further comprises one or more lenses 130, wherein the lens(es) 130 are adapted to focus light from the light source 150 and/or the laser source 600, after scattering by foreign matter within the immersion liquid, onto the light detector 120. The lens(es) 130 are proximate the first peripheral location, the second peripheral location, the third peripheral location, and/or the fourth peripheral location of the immersion head. As discussed above, the collection lens(es) 130 are placed away from the area of the (pattern) illumination (i.e., the exposure area X). In the first embodiment, in which the illumination source of the photo tool is used as the illumination source for the particle detector, it is advantageous that the particle detection system will only detect particles which lie in the optical path of the immersion system, i.e., in the “critical” fluid volume. The critical fluid volume is the fluid in the area above the wafer W which the exposure light passes through during the patterning process, as opposed to the immersion fluid laterally adjacent to the exposure area.

In addition, it is advantageous that the particle detectors are located around the periphery of the photo tool illumination area such that the scattered light from the particles must pass obliquely towards the detector. This allows particles on the wafer surface to be ‘filtered out’ of the defect inspection process by means of the absorption of their scattered light signal by the photoresist layer. This oblique angle signal detection enhances the relative signal of particles in the immersion fluid or on the resist surface. Also, interference from on-wafer topography (pattern) is minimized. If the system comprises a laser source, the lens(es) 130 are designed to allow the laser to travel parallel to and as close to the surface of wafer W as possible. As discussed above, the system 100 is insensitive to scattering of reflected light from the various surfaces (walls) of the immersion head (since the walls of the immersion head will not be illuminated during usual processes).

Embodiments herein further comprise a method for detecting foreign matter in an immersion lithography expose system, wherein the method begins by lithographically exposing a wafer W with light from a light source 150. As described above, the light is transmitted from the light source 150 and through a last stepper lens S. Next, the light is transmitted through an immersion liquid L covering the wafer W, wherein scattered light is scattered by the foreign matter within the immersion liquid L.

Subsequently, the scattered light is focused onto at least one light detector 120 via lens(es) 130, wherein the light detector 120 detects the scattered light. As described above, a signal from scattering particles/bubbles in the immersion liquid L is detected only from the area of interest, i.e., the exposure area X. Defects which remain confined to the periphery of the immersion head, i.e., outside of the exposure area X, will not contribute to defect measurement “noise”. In addition, because the scattered light is generated during the scan of the exposure field, correlation with wafer level defects can lead to easier debugging of defect generation. With this defect detection system, it may be possible to detect particles, bubbles, or other sources of defects within the immersion fluid as the wafer is exposed. In this way, defect sources can be characterized as a function of scan speed, location on the wafer (such as near the wafer edge, where turbulence in the immersion fluid may stir up particles from wafer or tool surfaces), flow rate of immersion fluid, vacuum and air flow levels used for containment of the immersion fluid, immersion head design or wafer stage design.

In addition, the method could comprise transmitting a laser beam (from a laser source 600) through the immersion liquid L, comprising orienting the laser beam parallel to the surface of wafer W. The laser beam is scattered by the foreign matter within the immersion liquid L to produce a scattered laser beam. Following this, the scattered laser beam is focused onto the light detector via lens(es), wherein the light detector detects the scattered laser beam. As described above, the lens(es) 130 are designed to allow the laser to travel as close to the wafer W as possible. This enables detection of fluid defects outside of the critical printing volume (but would necessitate having a laser which will not expose the resist).

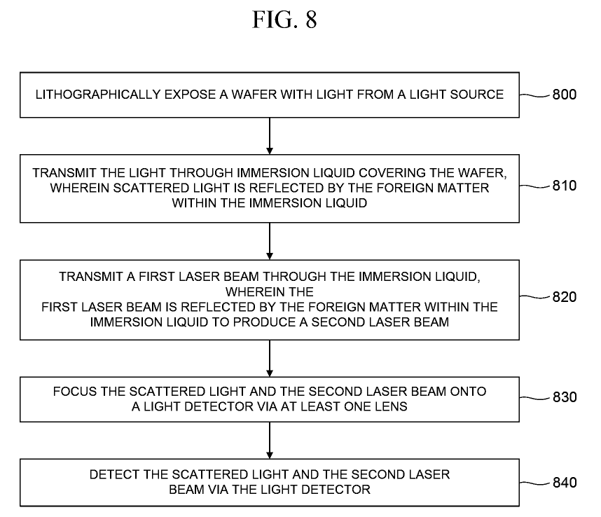

FIG. 8 illustrates a flow diagram of a method for detecting foreign matter in an immersion lithography expose system. In item 800 the method begins by lithographically exposing a wafer with light from a light source. As discussed above, the light is transmitted from the light source 150 and through a last stepper lens S. Next, in item 810, the method transmits the light through immersion liquid covering the wafer, wherein light is scattered by the foreign matter within the immersion liquid.

The method could also, in item 820, transmit a laser beam through the immersion liquid, wherein the laser beam is scattered by the foreign matter within the immersion liquid to produce a scattered laser beam. The transmitting of the laser beam through the immersion liquid comprises orienting the laser beam parallel to the wafer surface. As discussed above, the light source 150 and the laser source 600 cannot employ the same wavelength light, or the detection system will inadvertently expose the resist. Short wavelengths for laser source 600 are preferred since the shorter the wavelength the more efficient the scattering. Scattering is proportional to 1/(λ⁴) so that even a small wavelength decrease yields a large increase in scattering efficiency.

Following this, in item 830, the method focuses the scattered light onto at least one light detector via at least one lens. As discussed above, the collection lens(es) 130 are placed away from the area of the (pattern) illumination, so particles outside of the “critical” fluid volume are not counted. Also, interference from on-wafer topography (pattern) is minimized. Subsequently, in item 840, the scattered light is detected via the light detector.

The following description applies only to the first embodiment, in which the photo tool illumination source is used as the particle detection source. When a separate laser beam is used, as described in the second embodiment, it will inspect additional areas of the immersion fluid outside of the exposure area. If both of these techniques are used separately, bubbles or particles inside the critical expose area may be distinguishable from those outside of the critical expose area. This may help in tool design or operating conditions, such as flow rates of immersion fluid, shape of immersion head, vacuum and air flow levels used for containment of the immersion fluid, characterizing defects versus scan speed, defects versus immersion head location at wafer edge or center, and wafer stage design. As discussed above, a signal from scattering particles/bubbles in the immersion liquid L is detected only from the area of interest, i.e., the part of the immersion liquid L being irradiated by the light source 150 during exposure. Defects which remain confined to the periphery of the immersion head, outside of the normal exposure region, will not contribute to defect measurement “noise”.

Accordingly, embodiments of the invention provide a method for detecting defects and bubbles in the immersion fluid through monitoring of scattered exposure radiation. By using the light source that is already there, the amount of hardware changes needed is significantly reduced. In addition, the wavelength of the illumination is very short which yields higher sensitivity to small defects. Embodiments herein further provide a similar light collection mechanism built into the immersion head, with the addition of an independent light source.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. An immersion lithography expose system, comprising:
a wafer holder for holding a wafer;
an immersion liquid covering said wafer;
an immersion head containing said immersion liquid;
at least one light detector at a first location within said immersion head; and
a light source adapted to lithographically expose a resist on said wafer,
wherein said light source is further adapted to transmit light through said immersion liquid to said light detector to identify foreign matter within said immersion liquid.

2. The immersion lithography expose system according to claim 1, further comprising at least one lens, wherein said lens is adapted to focus light from said light source, after scattering by foreign matter within said immersion liquid, onto said light detector.

3. The immersion lithography expose system according to claim 2, wherein said lens is proximate at least one location along the periphery of said immersion head, a second location along the periphery of said immersion head, a third location along the periphery of said immersion head, and a fourth location along the periphery of said immersion head.

4. The immersion lithography expose system according to claim 2, further comprising a laser source at an additional location along the periphery of said immersion head, wherein said laser source is adapted to transmit light through said immersion liquid to scatter off of particles within said immersion liquid and thence to said light detector, to identify foreign matter within said immersion liquid.

5. The immersion lithography expose system according to claim 4, wherein said lens is further adapted to focus said light scattered from said particles onto said light detector.

6. The immersion lithography expose system according to claim 4, wherein said laser source and said light detector are positioned in an immersion head, and wherein said light source is positioned outside of said immersion head.

7. The immersion lithography expose system according to claim 1, wherein said light detector is proximate at least one of a second, a third, and a fourth position within said immersion head.

8. An immersion lithography expose system, comprising:
a wafer holder for holding a wafer;
an immersion liquid covering said wafer;
an immersion head confining said immersion liquid;
at least one light detector at a first position within said immersion head;
a light source adapted to lithographically expose a resist on said wafer; and
at least one lens adapted to focus light from said light source, after scattering off of foreign matter within said immersion liquid, onto said light detector.

9. The immersion lithography expose system according to claim 8, wherein said light source is further adapted to transmit light through said immersion liquid to said light detector to identify foreign matter within said immersion liquid.

10. The immersion lithography expose system according to claim 8, further comprising a laser source at a second location within said immersion head, wherein said laser source is adapted to transmit light through said immersion liquid to said light detector to identify foreign matter within said immersion liquid.

11. The immersion lithography expose system according to claim 10, wherein said lens is adapted to focus said light from said laser source, after scattering off of foreign matter within the immersion liquid, onto said light detector.

12. The immersion lithography expose system according to claim 10, wherein said laser source and said light detector are positioned in an immersion head, and wherein said light source is positioned outside of said immersion head.

13. The immersion lithography expose system according to claim 8,
wherein said light detector is further proximate at least one of a second location with said immersion head, a third location within said immersion head, and a fourth location within said immersion head; and
wherein said lens is proximate at least one of said first location, said second location, said third location, and said fourth location within said immersion head.

14. A method for detecting foreign matter in an immersion lithography expose system, comprising:
lithographically exposing a wafer with light from a light source;
transmitting said light through immersion liquid covering said wafer, wherein scattered light is reflected by said foreign matter within said immersion liquid; and
detecting said scattered light via at least one light detector.

15. The method of claim 14, further comprising focusing said scattered light onto said light detector via at least one lens.

16. The method of claim 14, further comprising:
transmitting a laser beam through said immersion liquid, wherein said laser beam is reflected by said foreign matter within said immersion liquid to produce a scattered laser beam; and
detecting said scattered laser beam via said light detector.

17. The method of claim 14, further comprising focusing said scattered laser beam onto said light detector via at least one lens.

18. A method for detecting foreign matter in an immersion lithography expose system, comprising:
lithographically exposing a wafer with light from a light source;
transmitting said light through immersion liquid covering said wafer, wherein light is scattered by said foreign matter within said immersion liquid
focusing said scattered light onto at least one light detector via at least one lens; and
detecting said scattered light via said light detector.

19. The method of claim 18, further comprising:
transmitting a laser beam through said immersion liquid, wherein said laser beam is scattered by said foreign matter within said immersion liquid to produce a scattered laser beam; and
detecting said scattered laser beam via said light detector.

20. The method of claim 19, further comprising focusing said scattered laser beam onto said light detector via at least one lens.
